(19) United States
(12) Patent Application Publication
(10) Pub. No.: US 2011/0085551 A1
(43) Pub. Date: Apr. 14, 2011

(54) STAGGERCASTING METHOD AND APPARATUS USING TYPE OF SERVICE (TOS) INFORMATION

(76) Inventors: Avinash Sridhar, Plainsboro, NJ (US); David Anthony Campana, Princeton, NJ (US); Shemimon Manalkudy Anthru, Monmouth, NJ (US)

(21) Appl. No.: 12/737,193

(22) PCT Filed: Jan. 27, 2009
(86) PCT No.: PCT/US09/00512

§ 371 Date: Dec. 16, 2010

Related U.S. Application Data
(62) Division of application No. 61/132,315, filed on Jun. 17, 2008.

(51) Int. Cl. H04L 12/56

(52) U.S. Cl. 370/392

(57) ABSTRACT

A stagger transmitter manipulates the Type of Service (TOS) information contained in packets transmitted therefrom. Downstream network devices, such as a network Multiplexer (MUX), use the TOS information to handle the packets. A MUX controls the bandwidth allocated to each of the original and staggered streams in accordance with the TOS information. The stagger transmitter manipulates the TOS information of packets in accordance with other information contained in the packets, such as Network Abstraction Layer (NAL) information. As such, the staggered stream copies of more important packets, as indicated by their NAL information, can have their TOS information set by the stagger transmitter so that a network MUX will forward such staggered packets in addition to the original packets, thereby providing redundancy and error protection for such packets.

### CROSS-REFERENCE TO RELATED APPLICATIONS

This application claims the benefit of U.S. Provisional Application No. 61/132,315, filed Jun. 17, 2008.

### FIELD OF THE INVENTION

The present invention relates to the field of digital transmission, and more particularly to the staggercasting of streams of packetized data.

### BACKGROUND INFORMATION

Many transmission systems, such as mobile wireless broadcast systems are subject to a difficult physical channel. In addition to fading and Doppler effects, the signal may be entirely obstructed by buildings, trees, poles, and overpasses, among other obstructions. This can easily cause signal loss for a period of a second or more. Staggercasting offers a method of protection against signal loss by transmitting a second, redundant stream which is time-shifted with respect to the primary stream. This allows a receiver to pre-buffer packets of the secondary stream to replace packets of the primary stream lost in transmission.

Techniques exist that allow a network stream to be coded so that it may carry Type of Service (TOS) information. In an Internet Protocol (IP) network, for example, this is accomplished by setting the TOS bits in the headers of IP packets. This additional information is passed on to other network devices downstream in the transmission path and can be used by those devices to determine the optimal path for the IP packet to reach its destination.

In most cases, the TOS information is used for network reliability, such as by routing packets differently. Doing so, however, will not necessarily have an impact on service if the number of network devices is minimal. For example, using the TOS bits will not impact any service that has only one router in its network since no other paths would be available.

### SUMMARY OF THE INVENTION

In accordance with the principles of the invention, a staggercasting method and apparatus manipulates Type of Service (TOS) information in staggercast packets in accordance with bandwidth conditions and/or packet importance. Downstream network devices can use the TOS information to handle packets accordingly. In an exemplary embodiment, a downstream network multiplexer can use the TOS information in determining the allocation of bandwidth to a primary stream of packets and a secondary or staggered stream of packets that are copies of the packets in the primary stream.

In a further exemplary embodiment, the TOS information of packets is manipulated in accordance with other information in the packets, such as Network Abstraction Layer (NAL) information. The staggered stream copies of more important packets, as indicated by their NAL information, will have their TOS information set so that a network multiplexer (MUX) will forward such staggered packets in addition to the primary stream packets, thereby providing redundancy and error protection for such packets.

The aforementioned and other features and aspects of the present invention are described in greater detail below.

### BRIEF DESCRIPTION OF THE DRAWINGS

FIG. 1 is a block diagram of an exemplary network arrangement with staggercasting.

FIG. 2 illustrates the format of a type of service (TOS) byte in the header of an internet protocol (IP) packet.

FIG. 3 illustrates the format of a Real-Time Transport Protocol (RTP) video stream packet.

FIG. 4 illustrates the operation of an exemplary embodiment of the present invention under high bandwidth availability conditions.

FIG. 5 illustrates the operation of an exemplary embodiment of the present invention under low bandwidth availability conditions.

FIG. 6 is a high-level flow chart illustrating the operation of a stagger transmitter in accordance with an exemplary embodiment of the present invention.

FIG. 7 is a high-level flow chart illustrating the operation of a multiplexer in accordance with an exemplary embodiment of the present invention.

### DETAILED DESCRIPTION

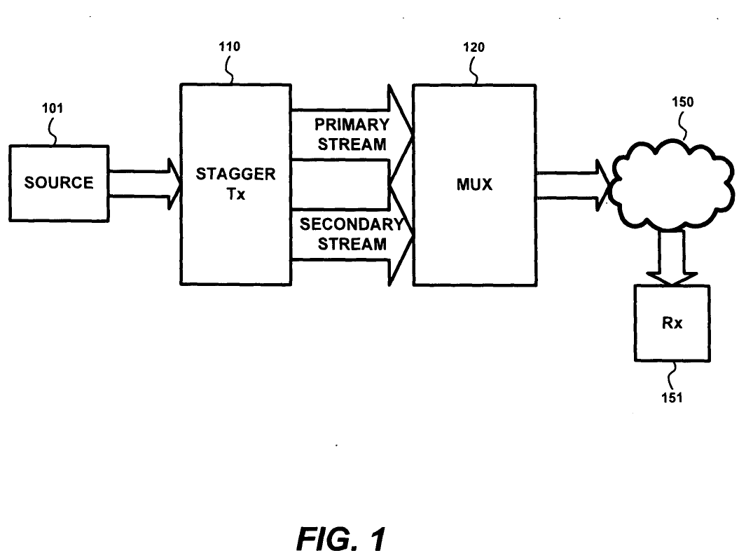

FIG. 1 is a block diagram of an illustrative arrangement comprising a stagger transmitter 110, a multiplexer (MUX) 120, a network 150 including other transmission/reception network elements, and a receiver 151. A source 101, such as a video encoder, provides an original stream of packets to the stagger transmitter 110, which, in turn, provides a staggercast transmission to the MUX 120. The output of the MUX 120 is coupled to a bandwidth-limited transmission channel carried by the network 150 to the receiver 151.

During normal operation, the staggercast transmission from the transmitter 110 to the MUX 120 comprises two streams. One stream, the primary stream, corresponds to the original stream from the source 101 and the other stream, the secondary stream, is a redundant copy of the primary stream. Note that for the purposes of the present invention, the headers of the primary stream packets can be different from the headers of the corresponding original stream packets, and the headers of the secondary stream packets can be different from the headers of the corresponding primary stream packets. Thus a primary stream packet may contain a payload that is the same as the payload of the corresponding original stream packet and a secondary stream packet may contain a payload that is the same as the payload of the corresponding primary stream packet.

The secondary stream is time-shifted or staggered relative to the primary stream, in which it will be referred to as a “staggered” stream. For example, the primary stream may be delayed with respect to the staggered stream. This allows the receiver 151 to pre-buffer packets of the staggered stream so that they may replace corresponding packets in the primary stream that may have been lost or corrupted in transmission.

Note that in the arrangement shown in FIG. 1, the source 101 provides a single stream, which is then re-transmitted by the transmitter 110 as part of a staggercast transmission of two streams. This, however, is only one of a variety of possible arrangements to which the present invention can be applied. For example, an arrangement in which the source 101 generates a staggercast transmission (with two streams) which is then received and re-transmitted by one or more staggercast transceivers in series could also be used with the present invention.

Additionally, in some applications, a secondary stream as contemplated by the present invention may already be available, as opposed to generating it with a stagger transmitter, as shown. For example, a specification may define multiple profiles for the transmission of content to mobile devices. These profiles can vary from very low resolution/frame rate/bitrate streams for viewing on simple mobile phones with small screens to higher resolution/frame rate/bitrate streams for mobile devices better capable of presenting video (having a larger screen, more powerful decoder, etc.) A system may simultaneously transmit a given video program in both profiles on the same channel so that users of either type of device may receive video that is optimal for their respective devices.

The MUX 120 receives the primary and secondary streams from the transmitter 110 and switches them through to its output for serial transmission via the network 150 to the receiver 151. Typically, the MUX 120 will also receive input streams from other sources (not shown) which it will selectively switch through to its output along with the streams from the transmitter 110. The bandwidth requirements of the various sources served by the MUX 120 will vary and may exceed the available bandwidth at the output of the MUX. When there is sufficient available bandwidth, the MUX 120 will be able switch both streams from the stagger transmitter 110 through to its output. In cases where the available channel bandwidth is insufficient, however, the MUX 120 may not be able to send both streams in their entirety. The MUX 120 could drop some packets in either or both streams due to this constraint. The determination by the MUX 120 of which packets to drop can be done in accordance with the Type of Service (TOS) information contained in the packet headers. The TOS information in the packet headers can be set by the stagger transmitter 110.

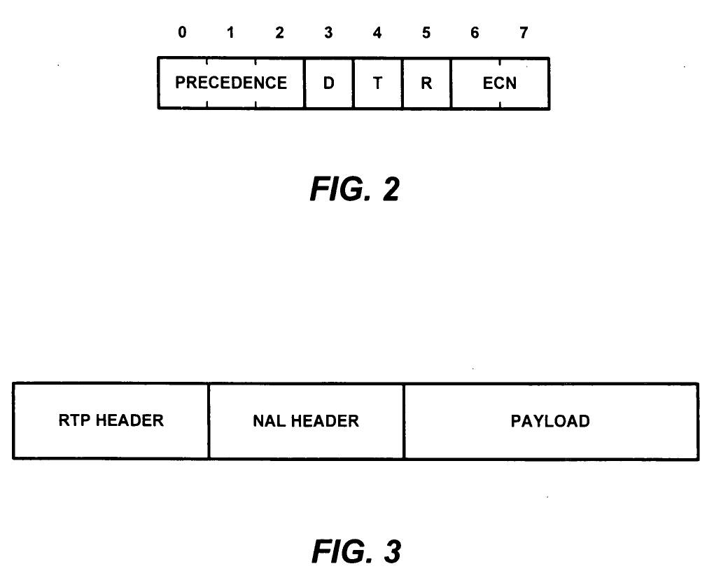

As shown in FIG. 2, there are eight bits reserved for TOS information in an IP header. The eight TOS bits, or TOS byte, can be divided into five subfields. The precedence subfield (bits 0-2), which can take on a value from 0 to 7, is used to indicate the importance of the packet, with 0 being the default value, and higher values indicating greater importance.

The D bit (bit 3) represents a request for low delay, the T bit (bit 4) a request for high throughput, and the R bit (bit 5) a request for high reliability.

The last two bits (bits 6 and 7) are reserved for Extension Congestion Notification (ECN). This is an extension to the Internet Protocol which allows end-to-end notification of network congestion without dropping packets.

In addition, or alternatively. Differentiated Services (or DiffServ) fields, as defined by RFC2474, can be used for TOS purposes. DiffServ fields contain DiffServ Code Points (DSCP) bits, an amalgamation of the previously defined TOS precedence bits and new DiffServ bits. This information is contained in a six-bit field that can be used to specify the priority of an IP packet.

It should be noted that the aforementioned protocols are presented by way of illustration and not limitation of the present invention. For simplicity, any “type of service” information, such as TOS or DSCP bits (or that of any other “type of service” standard) is referred to herein generically as TOS information.

Preferably, the stagger transmitter 110 sets the TOS information in the headers of individual packets in the secondary stream, as well as in the primary stream. The stagger transmitter 110 sets the TOS information of packets in accordance with the packets' relative importance.

The stagger transmitter 110 sets the TOS information to prioritize packets from the two streams differently. In an exemplary embodiment, the stagger transmitter 110 manipulates the TOS information so that packets in the primary stream will always get through a downstream network device, such as the MUX 120, and so that none, some or all packets in the secondary stream will get through. This can be done, for example, with the use of the three precedence bits in the TOS byte, as shown in FIG. 2, or with DSCP bits. For example, to impart a high priority to primary stream packets, so as to ensure their transmission when the available bandwidth is limited, the stagger transmitter 110 sets the TOS precedence bits (or the DSCP equivalent) of the primary stream packets to be high, e.g. 7 and those of the secondary or staggered stream to be low, e.g., 0. When there is sufficient available bandwidth, however, the MUX 120 can choose to forward the primary as well as the secondary stream packets, even if the stagger transmitter 110 has set the TOS information of the secondary stream packets to a low priority level.

There may be cases, however, where it is desirable for certain packets or groups of packets (or at least their payloads) in the primary stream to have duplicates thereof sent in the secondary stream. Such would be the case, for example, where due to the importance of the packets it is desirable to maintain a level of error correction for such packets. In such a case, the stagger transmitter 110 sets the TOS information equal for both streams so that the MUX 120 will not choose one stream over the other, but rather, will forward them both.

It is also possible to provide varying degrees of error protection by setting the TOS information of selected packets in the secondary stream to various levels so that the MUX 120 will pass them on to the output stream under different bandwidth conditions. For example, if the stagger transmitter 110 sets the priority level of a secondary stream packet to the highest level (e.g., 7), it will, or most likely will, be forwarded by the MUX 120 under all bandwidth conditions, and if it set to the lowest level (e.g., 0) it will most likely be forwarded by the MUX only when there is sufficient available bandwidth. If the stagger transmitter 110 sets the priority level of a secondary stream packet to an intermediate level (e.g., 4), however, there will be some bandwidth conditions during which the packet will be forwarded and others in which it will not, with the likelihood of it being forwarded increasing as bandwidth availability increases. By transmitting some of the secondary stream packets along with the primary stream packets, a level of error protection is maintained, with the level of protection increasing as the number of secondary stream packets transmitted increases.

In a video implementation, the TOS information of a packet can be set in accordance with the type of the video stream packet. For example, as shown in FIG. 3, a normal H264 Real-Time Transport Protocol (RTP) video stream packet contains an RTP header and a Network Abstraction Layer (NAL) header followed by a video payload. The NAL header contains information specific to the video payload. The NAL header can specify a variety of things about the video packet, including, for example, whether the video packet is a whole packet or a fragmented packet, or whether the video packet contains or is part of a key frame such as an 1-Frame (Intra-Frame) or a P-Frame (Predictive-Frame), among other things.

A stagger transmitter that is NAL-aware, can read the information in the NAL header of a packet and determine the importance of a packet. The NAL-aware stagger transmitter can then set the TOS information of the packet accordingly. In addition, the stagger transmitter can also set the TOS information of a secondary stream copy of the packet accordingly.

For example, because an I-Frame is important to a video decoder for decoding video, it may be desirable, even in a condition of low bandwidth availability, to provide the decoder with a staggered copy of the I-frame. To accomplish this, the stagger transmitter 110 sets the TOS information for secondary stream copies of such packets to a priority value as high as that of the primary stream packets so that the MUX 120 will pass those packets on through to its output. As such, the secondary stream is allocated some of the available bandwidth for transmission from the MUX 120. Other, less important types of frame data can receive a lower precedence or DSCP priority standing from the stagger transmitter 110, so that the MUX 120 could determine to drop some or all of such packets if need be.

Additionally, there may be circumstances in which it is desirable or necessary to ensure the transmission through the MUX 120 of a sequence of multiple packets in the staggered stream. For example, an I-Frame may be comprised of more than one packet. The stagger transmitter 110 sets the TOS information in packets containing parts of an I-Frame to a high priority level in order to ensure that those packets are passed on by the MUX 120 for transmission. This can apply to packets in both the primary and secondary streams so as to ensure that the entire I-Frame as well as a staggered copy thereof are passed on by the MUX 120.

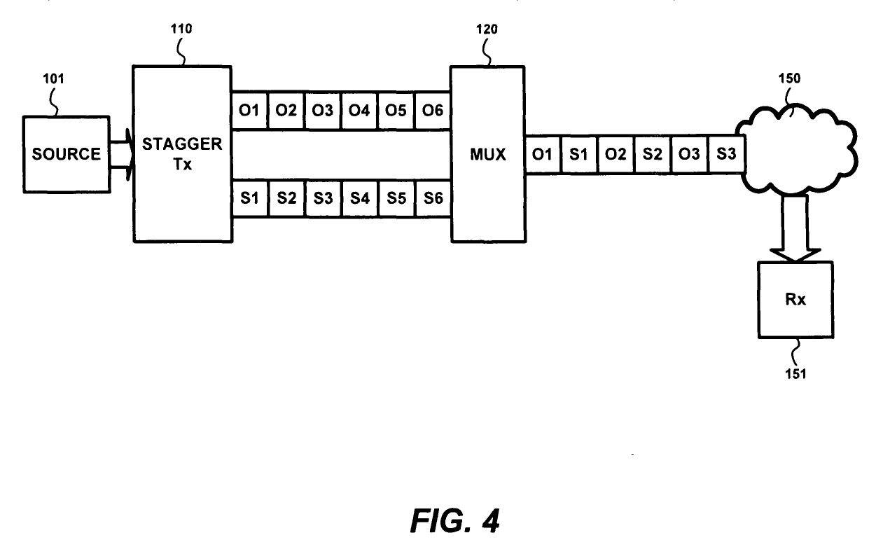

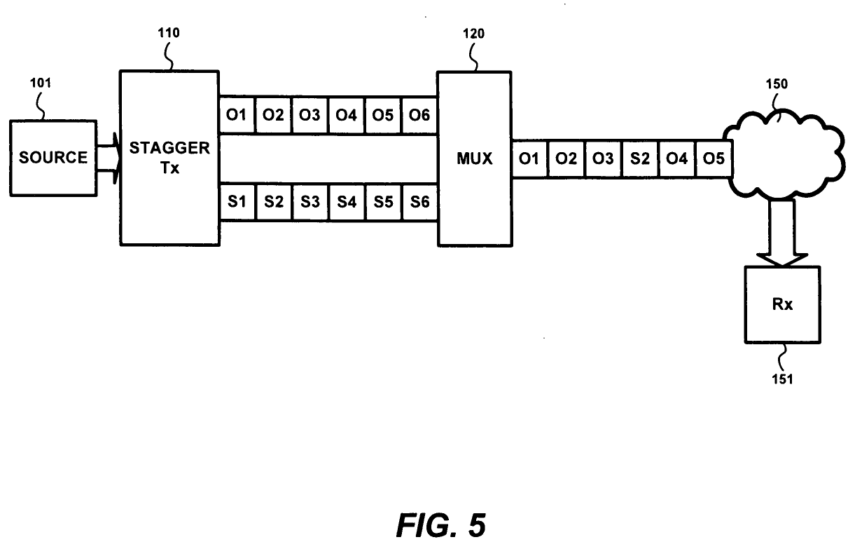

FIGS. 4 and 5 illustrate the operation of the above-describe scheme under high bandwidth availability and low bandwidth availability, respectively. The packets from the original stream are labeled O1, O2, . . . and are passed on by the stagger transmitter through to the primary stream and the corresponding packets in the secondary or staggered stream are labeled S1, S2, . . . . In this illustration, assume that S2 contains or is part of an I-Frame and the remaining packets contain or are part of either P or B-Frames (Bi-directional Frames).

In the high bandwidth scenario of FIG. 4, because there is enough available bandwidth for both streams, the MUX 120 switches packets from both streams to its output. It should be noted that the MUX output stream is shown in FIG. 4 as an interleaved pattern for simplicity, although any pattern that yields an equal bandwidth for the primary and staggered streams can be used.

In the low bandwidth scenario of FIG. 5, there is not enough available bandwidth for the MUX 120 to switch all packets from both streams to its output. In this case, the MUX 120 relies on the TOS information as set by the stagger transmitter 110 to selectively switch packets to its output. For the I-Frame in packet S2 of the staggered stream, the stagger transmitter 110 sets a high priority value: e.g., a TOS precedence value of 7 or an equivalent DSCP value. The remaining staggered stream packets are given lower TOS precedence values, such as 0 or 1, or an equivalent DSCP value. As a result, as illustrated in FIG. 5, the MUX 120 switches more of the primary stream packets to its output since they have a higher priority value than most of the staggered stream packets.

If conditions are such that the available bandwidth can only allow one stream, the stagger transmitter 110 sets the TOS precedence or DSCP bits of the staggered stream in such a way that only the primary stream gets through the MUX 120. In such a case, the stagger transmitter 110 gives the staggered stream packets a TOS precedence value of 0 or equivalent DSCP value. With no staggered stream packets, however, there would be no protection against errors in the channel.

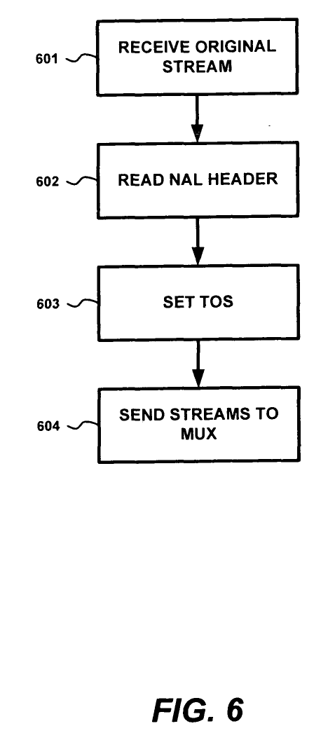

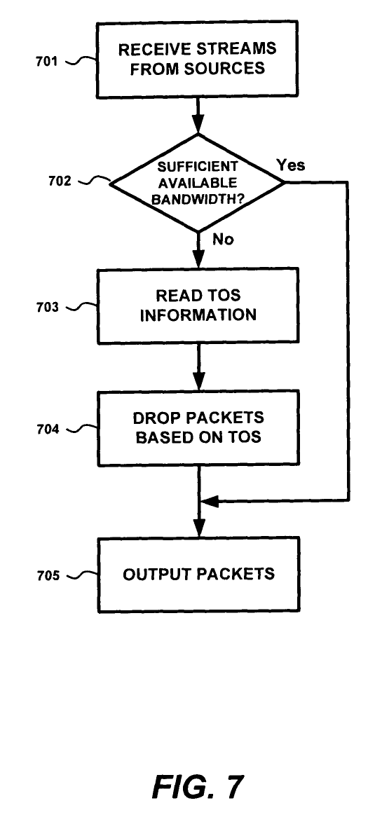

FIGS. 6 and 7 are high-level flow charts illustrating the operation of the stagger transmitter and MUX, respectively, in accordance with an exemplary embodiment of the present invention. As shown in FIG. 6, at step 601, the stagger transmitter receives one or more packets in the original stream from the source. At 602, the stagger transmitter reads the contents of the NAL header of the received packets to determine their types and thus their relative importance. At 603 the stagger transmitter sets the TOS information for the corresponding packets of the primary and/or secondary streams in accordance with the NAL header information, as described above. At 604, the packets are then transmitted over the primary and secondary streams to the MUX.

As shown in FIG. 7, at 701, the MUX receives the input streams of data from the various sources that it serves, including the primary and secondary streams from the stagger transmitter. At 702, based on the bandwidth demand as represented by the input streams, a determination is made as to whether there is sufficient available bandwidth to satisfy all of the input streams. If so, operation jumps to 705, in which all packets in the input stream are output by the MUX. If, however, it is determined at 702 that there is not sufficient available bandwidth, the MUX, at 703, looks at the TOS information contained in the packet headers to determine which packets to drop, at 704. At 705, the MUX will output the remaining packets.

Note that while a video implementation has been described above for illustration of the present invention the present invention can be applied to a variety of packetized streams with TOS information, including, for example, audio and file-transfer applications. Thus, for example in an audio application, the stagger transmitter can parse network data contained in an audio stream and use that to manipulate the TOS information in packets of the audio stream. Moreover, although an embodiment has been described in which NAL information is used to determine packet importance in a video implementation, for other codec applications analogous codec-related header information will be used for this purpose.

It is understood that the above-described embodiments are illustrative of only a few of the possible specific embodiments which can represent applications of the invention. Numerous and varied other arrangements can be made by those skilled in the art without departing from the spirit and scope of the invention.

1. A method of stagger casting a stream of packets comprising:
receiving an original stream packet, the original stream packet including a header with identifying information;
determining a type of service (TOS) information in accordance with the identifying information;
transmitting a primary stream packet corresponding to the original stream packet; and
transmitting a secondary stream packet, the secondary stream packet including a header containing the TOS information and a payload corresponding to a payload of the primary stream packet;
wherein the primary and secondary stream packets are transmitted with a time offset therebetween.

2. The method of claim 1 comprising determining a further TOS information in accordance with the identifying information, wherein the primary stream packet includes a header containing the further TOS information.

3. The method of claim 1, wherein the TOS information includes at least one of TOS precedence bits, and DiffServ Code Points (DSCP) bits.

4. The method of claim 1 comprising:
multiplexing the primary and secondary stream packets onto an output stream in accordance with the TOS information.

5. The method of claim 4, wherein the TOS information contains a priority value and wherein the multiplexing assigns a portion of available bandwidth of the output stream to the primary and secondary stream packets in accordance with the priority value.

6. The method of claim 1, wherein the identifying information includes codec header information.

7. The method of claim 9, wherein the codec header information includes H264 Real-Time Transport Protocol (RTP) Network Abstraction Layer (NAL) information.

8. Apparatus comprising:
a source of packets for providing an original stream of packets, each packet comprising a payload for conveying video and a header for conveying identifying information about the video payload; and
a staggercasting transmitter for providing a primary stream of packets corresponding to the original stream of packets and at least one secondary stream of packets corresponding to the original stream of packets, wherein there is a time offset between the primary stream and the at least one secondary stream and wherein the staggercasting transmitter sets type of service information in the packets of the primary stream and in the packets of the secondary stream in accordance with the identifying information.

9. The apparatus of claim 8, wherein the type of service information includes at least one of TOS precedence bits, and DiffServ Code Points (DSCP) bits.

10. The apparatus of claim 8, comprising:
a multiplexer for multiplexing the primary stream and the at least one secondary stream into an output stream in accordance with the type of service information.

11. The apparatus of claim 10, wherein the type of service information comprises a priority value and wherein the multiplexer assigns a portion of available bandwidth of the output stream to the primary stream and the at least one secondary stream in accordance with the priority value.

12. The apparatus of claim 9, wherein the identifying information includes codec header information.

13. The apparatus of claim 12, wherein the codec header information includes H264 Real-Time Transport Protocol (RTP) Network Abstraction Layer (NAL) information.
